(19) United States
(12) Patent Application Publication
(10) Pub. No.: US 2026/0312285 A1
(43) Pub. Date: Oct. 8, 2026

(54) METHOD AND SYSTEM FOR COMBINED SCANNING ANTENNA

(71) Applicant: SatixFy UK Limited, Farnborough (GB)

(72) Inventor: Daniel FRAI, Farnborough (GB)

(73) Assignee: SatixFy UK Limited, Farnborough (GB)

(21) Appl. No.: 19/097,989

(22) Filed: Apr. 2, 2025

(51) Int. Cl. H01Q 3/36; H01Q 1/28

(52) U.S. Cl. CPC H01Q 3/36; H01Q 1/288

(57) ABSTRACT

Methods and system for combined scanning antenna are provided herein. An antenna system for beamforming and beamsteering may include: an antenna array which includes: a phased array configured to form a single beam; and a digital beamforming array configured to form a plurality of beams. The antenna system may further include: a mechanical actuator configured to rotate the antenna array; and a combiner configured to combine at least one of the plurality of digitally formed beams with the single phased array beam to form a new beam, wherein the new beam has a higher gain than any one of the plurality of digitally formed beams or the single phased array beam.

### FIELD OF THE INVENTION

The present invention relates to the field of beamforming and beamsteering, and in particular to hybrid antenna systems.

### BACKGROUND OF THE INVENTION

Three main technologies for forming array antennas are known in the art. One known technology is fixed connection, which enables the formation of a single beam and steering it to a desired direction by mechanical rotation. A second known technology is phased array, which enables the formation of a single beam and steering it to a desired direction by electronic steering. A third known technology is digital beamforming, which enables the creation of multiple beams and steering them in any desired direction and polarization.

However, digital beamforming requires digital receivers or transmitters at every element, which can be expensive and power consuming.

Antennas that use combined techniques are also known in the art. One example is hybrid array, wherein the antenna elements are partitioned into sub-arrays, within which the elements are connected by fixed connection or phase shifters, while the sub-arrays are connected by digital beamforming techniques.

A second example consists of fixed linear arrays stacked vertically and connected by phase shifters, enabling the formation of a single beam which can be rotated mechanically in azimuth and steered electronically in elevation.

A third example consists of fixed linear arrays arranged horizontally and connected by digital beamforming techniques, enabling the formation of multiple beams which can be steered across a spherical volume (i.e. in azimuth and elevation) without the need for mechanical rotation.

However, none of the above techniques are able to simultaneously communicate with both geostationary (GEO) satellites and low Earth orbit (LEO) satellites from a fixed or mobile terrestrial, airborne, or maritime terminal.

GEO satellite communication requires a large, directional antenna pointed at fixed satellite, able to perform tracking at a speed on the order of the Earth's rate of rotation, i.e. relatively slowly, across large angles. Conversely, LEO satellite communication requires faster tracking across smaller angles. This requires the use of multiple beams which results in low directivity.

“Signal”, “radiation”, “wave”, “beam” and similar may refer herein to the electromagnetic radio waves transmitted and/or received by an antenna. Further, “strength”, “intensity”, “density”, “concentration” or similar in reference to “signal”, “radiation”, “power” or similar shall correspond to the power level of said radio wave.

“Directivity” is a measure of how well an antenna directs energy toward a particular direction. In particular, directivity is the ratio of power density in a given direction to the power density averaged over all directions at the same distance from the antenna.

“Gain” is directly proportional to directivity and as such may be used interchangeably with directivity throughout the specification. A high-gain antenna, also known as a directional antenna, transmits or receives radiation concentrated in a certain direction; it has a focused narrow beam coverage. A low-gain antenna has a broader beam coverage and can transmit or receive radiation across a wider range of directions.

### SUMMARY OF THE INVENTION

According to one or more embodiments of the invention, there is provided: an antenna system for beamforming and beamsteering comprising: an antenna array comprising: a phased array configured to form a single beam; and a digital beamforming array configured to form a plurality of beams; a mechanical actuator configured to rotate the antenna array; and a combiner configured to combine at least one of the plurality of digitally formed beams with the single phased array beam to form a new beam, wherein the new beam has a higher gain than any one of the plurality of digitally formed beams or the single phased array beam.

According to some embodiments, the phased array is configured to electronically steer the single beam across any elevation, wherein the single beam has any polarization; and the mechanical actuator is configured to rotate the phased array across any azimuth.

According to some embodiments, the digital beamforming array is configured to electronically steer each of the plurality of beams across any elevation and any azimuth, wherein each of the plurality of beams has any polarization.

According to some embodiments, the mechanical actuator is configured to rotate the digital beamforming array, and the digital beamforming array is configured to electronically steer the plurality of beams independently of the mechanical rotation.

According to some embodiments, the antenna array is of the integrated transmit and receive type.

According to some embodiments, the antenna system may include a separate transmit-type antenna array and receive-type antenna array configured to perform, respectively, transmit and receive functions simultaneously.

According to some embodiments, the antenna system is configured for simultaneous communication with both geostationary (GEO) satellites and low Earth orbit (LEO) satellites, wherein the phased array has a first antenna gain and steers the single beam at a first speed corresponding to GEO satellite orbit, wherein the digital beamforming array has a second antenna gain and steers the plurality of beams at a second speed corresponding to LEO satellite orbit, wherein the first gain is higher than the second gain and the first speed is slower than the second speed.

According to some embodiments, the combiner comprises a beamforming integrated circuit, configured to set parameters, such as amplitude, phase and time delay, required to combine more than one beam.

According to one or more embodiments of the invention, there is provided a method for an antenna configured for beamforming and beamsteering comprising; forming, using a phased array, a single beam; forming, using a digital beamforming array, a plurality of beams; mechanically rotating an antenna array comprising the phased array and the digital beamforming array; and combining at least one of the plurality of digitally formed beams with the single phased array beam to form a new beam, wherein the new beam has a higher gain than any one of the plurality of digitally formed beams or the single phased array beam..

According to some embodiments, the method further comprises electronically steering, using the phased array, the single beam across any elevation, wherein the single beam has any polarization; and mechanically rotating the phased array to any azimuth.

According to some embodiments, the method further comprises electronically steering, using the digital beamforming array, each of the plurality of beams across any elevation and any azimuth, wherein each of the plurality of digitally formed beams has any polarization.

According to some embodiments, the method further comprises mechanically rotating the digital beamforming array, wherein the plurality of digitally formed beams can be electronically steered, using the digital beamforming array, independently of the mechanical rotation.

According to some embodiments, the method further comprises configuring a separate transmit-type antenna array and receive-type antenna array to perform, respectively, transmit and receive functions simultaneously.

According to some embodiments, the method is configured for simultaneous communication with both geostationary (GEO) satellites and low Earth orbit (LEO) satellites, comprising: steering the single phased array beam at a first speed corresponding to GEO satellite orbit, wherein the single phased array beam has a first gain; steering the plurality of digitally formed beams at a second speed corresponding to LEO satellite orbit, wherein the plurality of digitally formed beams has a second gain, wherein the first gain is higher than the second gain and the first speed is slower than the second speed.

According to some embodiments, combining the beams comprises setting parameters, such as amplitude, phase and time delay, required to combine a plurality of beams.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the following accompanying drawings:

FIG. 1 is a schematic diagram of an antenna structure according to some embodiments of the invention;

FIG. 2 is a schematic diagram of an antenna structure according to some embodiments of the invention;

FIG. 3 is a schematic diagram of an exemplary implementation of an antenna structure according to some embodiments of the invention; and

FIG. 4 is a flowchart of a method for an antenna configured for beamforming and beamsteering.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

The present invention provides a system capable of forming and steering a plurality of beams, while maintaining a strong signal in all directions. The invention combines the long-range capabilities of a directive antenna with the azimuthal coverage of a multi-beam antenna. Further, by combining mechanical rotation with electronic steering, the present invention provides a cost-effective way of utilizing digital beamforming capabilities by reducing the number of digital receivers or transmitters required.

The present invention has various use cases. For example, it may perform simultaneous communication with GEO satellites and LEO satellites. It may also be used for point-to-point ground communication.

FIG. 1 shows a combined antenna structure 100 with a combined antenna array comprising two types of array, array type 110 and array type 120. An example beam 150 that may be produced by either and/or both of the array types is shown on a 3D coordinate axis, having azimuthal angle θ and elevation angle α. Beam 150 may be polarized, for example linearly or circularly.

Array type 110 may form a singular beam and array type 120 may form a plurality of beams. Array type 120 may be able to steer each of the plurality of beams independently.

Array type 110 may have electronic scanning and beamforming capabilities across any elevation and at any polarization, within a single fixed azimuth. The second array type 120 may have electronic scanning and beamforming capabilities across any elevation and any azimuth, and at any polarization. Electronic scanning and beamforming may involve beams in the radio frequency (RF) range of the electromagnetic spectrum.

Arrays 110 and 120 may be fixed to the upper surface of combined antenna structure 100.

The combined antenna structure 100 may be rotated around an axis centred on pivot point 140 such that both array types 110 and 120 have mechanical scanning capabilities in addition to the electronic scanning capabilities. In particular, the mechanical rotation provides array type 110 with mechanical scanning capability across any azimuth. Therefore, array type 110 may have combined mechanical and electronic scanning capabilities enabling it to scan and form beams across any elevation, azimuth and polarization.

Thus, array type 120 may perform an fully electronic 2D scan, and array type 110 may perform a hybrid or combined 2D scan. According to some embodiments, array type 110 may be a phased array and array type 120 may be a digital beamforming array.

Array type 110 may be configured for communication with slow-moving satellites with large orbits (~10⁴ km), allowing a higher gain (a narrower, more focused beam) and requiring minimal and/or slow mechanical rotation. Array type 120 may be configured for communication with faster-moving satellites in closer orbits (10²-10³ km), having a lower gain (producing a plurality of beams with wide beamwidths) and allowing fast steering.

The array type 120 may steer and control its beams electronically, independently of the mechanical rotation of the antenna structure 100. For example, antenna structure 100 may rotate slowly to track a slow-moving satellite using array 110, while array 120 may steer a plurality of beams to track a fast-moving satellite. In particular, the array 120 is able to electronically counteract and/or compensate for the mechanical rotation of the structure 100 such that its beams remain fixed on the fast-moving satellite.

Arrays 110 and 120 may be configured specifically for communication with GEO and LEO satellites, respectively. A combination of mechanical and electronic steering may allow array 110 to remain effectively stationary to track a GEO satellite, while array 120 tracks a mobile LEO satellite.

According to some embodiments, the mechanical rotation mechanism may be carried out using a mechanical actuator and/or a combination of motors and gimbals.

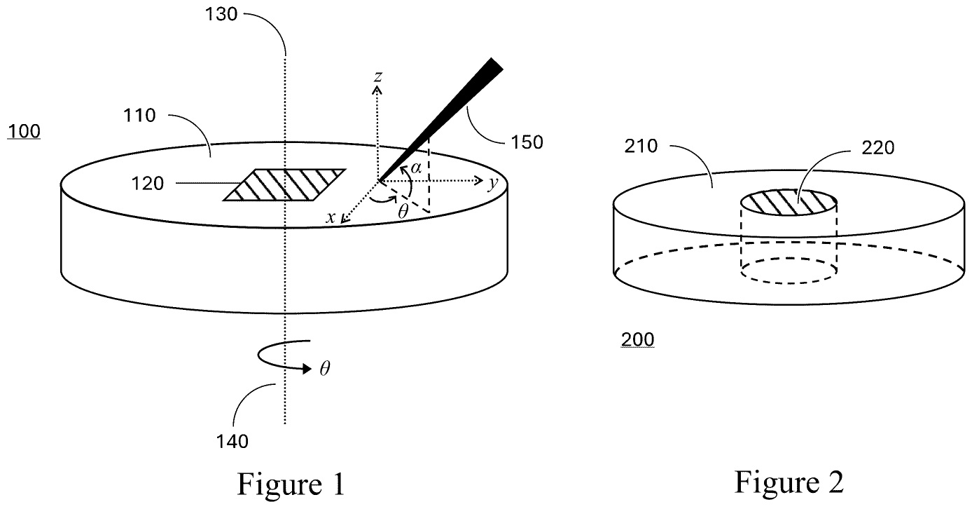

FIG. 2 shows a combined antenna structure 200 similar to antenna structure 100, with array types 210 and 220 similar to 110 and 120 respectively.

According to this embodiment, array 210 is fixed to the surface of the combined antenna structure 200 but array 220 is not. For example, both arrays 210 and 220 may be circular, such that array 210 may mechanically rotate around array 220 which remains stationary.

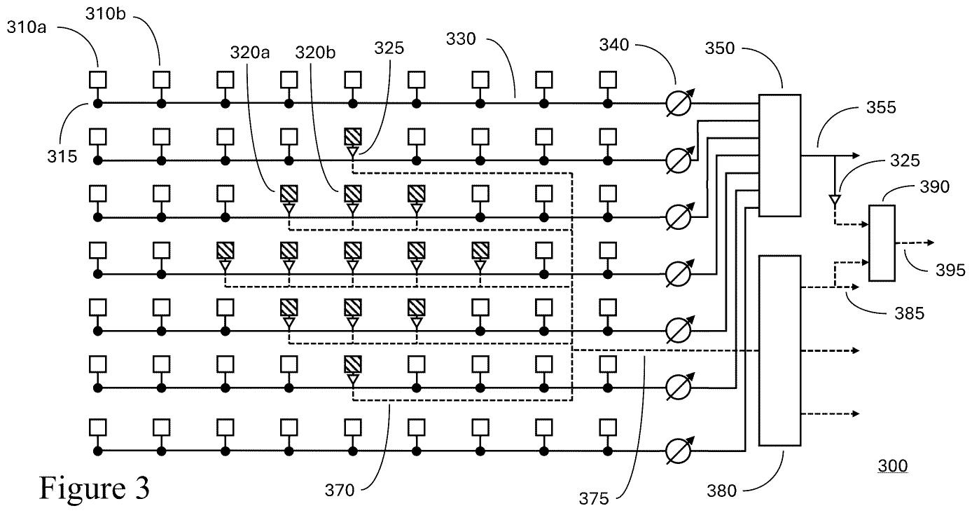

FIG. 3 shows a circuit diagram of a receive-type array architecture 300 that may correspond to the combined antenna structure 100. Elements 310 (e.g. 310a and 310b) and 320 (e.g. 320a and 320b) are antennas. The outputs of elements 310 may be summed across each row using RF summers 315 and transmitted across RF lines 330. The output of each row may be shifted in phase by an analogue phase shifter 340 and the phase-shifted outputs may be combined by an RF summer 350 to form a beam 355. The resulting beam may have a narrow antenna pattern in the horizontal direction with electronic scanning capabilities in the vertical direction. This part of the array may correspond to array type 110.

The outputs of elements 320 are not summed with the outputs of elements 310; instead, they may be digitized by analogue-to-digital (ADC) converters 325 and collected by and transmitted across digital bus cable 370. A digital beamformer processor 380 may use output signal 375 to produce a set of beams in various directions. This part of the array may correspond to array type 120.

A digitally-formed beam 385 with similar pointing parameters to the beam 355 may be combined with beam 355 to form a new beam 395. The pointing parameters may include, for example, direction, amplitude, phase and/or time delay. Analogue beam 355 may be digitized by an ADC 325 and beams 355 and 385 may be combined by a beam combiner 390. The new combined beam 395 may have the full range and strong signal of the array type 110 beam, as well as the full azimuthal coverage of the array type 120 beams. The beam 395 may be independently controlled and steered.

According to some embodiments, the combining process, involving combiner 390, may be implemented by means of a digital beamforming integrated circuit device.

Receive array architecture 300 may be implemented as a transmit array wherein: the direction of the signal is reversed; the ADCs 325 are replaced by digital-to-analogue converters (DACs); and the RF summers 315 and 350 are replaced by RF splitters.

According to some embodiments, array 300 may be of the integrated transmit and receive type. According to other embodiments, the antenna system may include separate transmit and receive arrays synchronised to perform transmit and receive functions simultaneously.

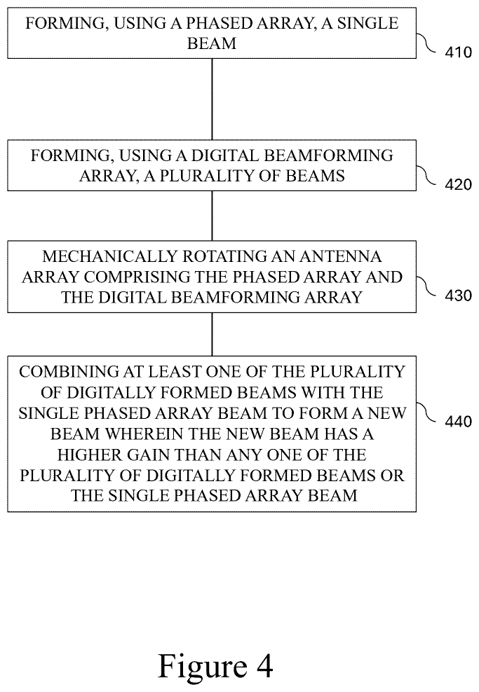

FIG. 4 shows a flowchart of a method 400 for an antenna configured for beamforming and beamsteering, according to some embodiments of the invention.

Method 400 includes forming, using a phased array, a single beam (step 410); and forming, using a digital beamforming array, a plurality of beams (step 420). The phased array may be array type 110 and the digital beamforming array may be array type 120.

Method 400 further includes mechanically rotating an antenna array (step 430). Step 430 may be carried out using a combination of motors and gimbals.

Method 400 further includes combining at least one of the plurality of digitally formed beams with the single phased array beam to form a new beam, wherein the new beam has a higher gain than any one of the plurality of digitally formed beams or the single phased array beam (step 440). Step 440 may be carried out using a beam combiner, for example beam combiner 390.

In the above description, an embodiment is an example or implementation of the inventions. The various appearances of “one embodiment”, “an embodiment”, or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. An antenna system for beamforming and beamsteering comprising:
an antenna array comprising:
a phased array configured to form a single beam; and
a digital beamforming array configured to form a plurality of beams;
a mechanical actuator configured to rotate the antenna array; and
a combiner configured to combine at least one of the plurality of digitally formed beams with the single phased array beam to form a new beam,
wherein the new beam has a higher gain than any one of the plurality of digitally formed beams or the single phased array beam.

2. The system according to claim 1, wherein the phased array is configured to electronically steer the single beam across any elevation, wherein the single beam has any polarization; and the mechanical actuator is configured to rotate the phased array across any azimuth.

3. The system according to claim 1, wherein the digital beamforming array is configured to electronically steer each of the plurality of beams across any elevation and any azimuth, wherein each of the plurality of beams has any polarization.

4. The system according to claim 1, wherein the mechanical actuator is configured to rotate the digital beamforming array, and wherein the digital beamforming array is configured to electronically steer the plurality of beams independently of the mechanical rotation.

5. The system according to claim 1, wherein the antenna array is of an integrated transmit and receive type.

6. The system according to claim 1, wherein the antenna system comprises a separate transmit-type antenna array and receive-type antenna array configured to perform, respectively, transmit and receive functions simultaneously.

7. The system according to claim 1, configured for simultaneous communication with both geostationary (GEO) satellites and low Earth orbit (LEO) satellites,
wherein the phased array has a first antenna gain and steers the single beam at a first speed corresponding to GEO satellite orbit,
wherein the digital beamforming array has a second antenna gain and steers the plurality of beams at a second speed corresponding to LEO satellite orbit,
wherein the first gain is higher than the second gain and the first speed is slower than the second speed.

8. The system according to claim 1, wherein the combiner comprises a beamforming integrated circuit, configured to set parameters, such as amplitude, phase and time delay, required to combine more than one beam.

9. A method for an antenna configured for beamforming and beamsteering comprising;
forming, using a phased array, a single beam;
forming, using a digital beamforming array, a plurality of beams;
mechanically rotating an antenna array comprising the phased array and the digital beamforming array; and
combining at least one of the plurality of digitally formed beams with the single phased array beam to form a new beam,
wherein the new beam has a higher gain than any one of the plurality of digitally formed beams or the single phased array beam.

10. The method according to claim 9, further comprising electronically steering, using the phased array, the single beam across any elevation, wherein the single beam has any polarization; and mechanically rotating the phased array to any azimuth.

11. The method according to claim 9, further comprising electronically steering, using the digital beamforming array, each of the plurality of beams across any elevation and any azimuth, wherein each of the plurality of digitally formed beams has any polarization.

12. The method according to claim 9, further comprising mechanically rotating the digital beamforming array, wherein the plurality of digitally formed beams can be electronically steered, using the digital beamforming array, independently of the mechanical rotation.

13. The method according to claim 9, further comprising configuring a separate transmit-type antenna array and receive-type antenna array to perform, respectively, transmit and receive functions simultaneously.

14. The method according to claim 9, configured for simultaneous communication with both geostationary (GEO) satellites and low Earth orbit (LEO) satellites, comprising:
steering the single phased array beam at a first speed corresponding to GEO satellite orbit, wherein the single phased array beam has a first gain;
steering the plurality of digitally formed beams at a second speed corresponding to LEO satellite orbit, wherein the plurality of digitally formed beams has a second gain,
wherein the first gain is higher than the second gain and the first speed is slower than the second speed.

15. The method according to claim 9, wherein combining the beams comprises setting parameters, such as amplitude, phase and time delay, required to combine a more than one beam.
